(19) United States
(12) Patent Application Publication
(10) Pub. No.: US 2013/0232977 A1
(43) Pub. Date: Sep. 12, 2013

(54) FUEL NOZZLE AND A COMBUSTOR FOR A GAS TURBINE

(71) Applicants: Prabhu Kumar Ippadi Siddagangaiah, Bangalore (IN); Karthick Kaleeswaran, Bangalore (IN)

(72) Inventors: Prabhu Kumar Ippadi Siddagangaiah, Bangalore (IN); Karthick Kaleeswaran, Bangalore (IN)

(73) Assignee: GENERAL ELECTRIC COMPANY, Schenectady, NY (US)

(21) Appl. No.: 13/415,145

(22) Filed: Mar. 8, 2012

(51) Int. Cl. F23R 3/28; F02C 7/22

(52) U.S. Cl. 60/737

(57) ABSTRACT

A fuel nozzle for a gas turbine includes an annular passage configured to flow a fuel and a disk concentric with and disposed at a second end of the annular passage. The disk extends radially outward from the second end. A plurality of passages extend through the disk and are configured to impart swirl to a working fluid flowing through the passages. A shroud including an upstream end axially separated from a downstream end surrounds the disk and extends downstream from the disk.

### FIELD OF THE INVENTION

The present invention generally involves a fuel nozzle and a combustor for a gas turbine.

### BACKGROUND OF THE INVENTION

Gas turbines generally include a combustor with one or more fuel nozzles positioned about an end cover in various configurations. For example, some combustors may include a six fuel nozzle configuration which includes a center fuel nozzle surrounded by five outer fuel nozzles. In particular combustor designs, the fuel nozzle(s) extend downstream from the end cover and at least partially through one or more annular passage(s) of a cap assembly. Typically, the annular passage(s) includes an annular impingement sleeve disposed concentrically within the annular passage and/or a floating collar coupled to the impingement sleeve and/or the cap assembly. During assembly of the combustor, the fuel nozzle(s) are generally positioned so that a radial gap exists between the fuel nozzle and the floating collar.

In operation, a fuel and/or a working fluid flow through the fuel nozzle(s) and into the floating collar before exiting the cap assembly for combustion in a combustion zone within the combustor. However, during operation the floating collar may shift radially and/or axially due to combustor dynamics, thermal growth and/or compressor discharge pressures within the combustor, thereby contacting the fuel nozzle(s) and potentially reducing the mechanical life of the fuel nozzle(s) and/or the cap assembly.

Improved floating collar designs, however, may result in increased manufacturing, maintenance, and repair costs. For example, improved floating collar designs typically incorporate costly wear resistant materials. However, these materials do not prevent the collar from contacting the fuel nozzle. Therefore, an improved fuel nozzle design that eliminates the floating collar from the cap assembly would be useful.

### BRIEF DESCRIPTION OF THE INVENTION

Aspects and advantages of the invention are set forth below in the following description, or may be obvious from the description, or may be learned through practice of the invention.

One embodiment of the present invention is a fuel nozzle for a gas turbine. The fuel nozzle includes an annular passage configured to flow a fuel and includes a first end axially separated from a second end. A disk concentric with the annular passage is disposed at the second end and extends radially outward from the second end. A plurality of passages extend through the disk from an upstream surface of the disk to a downstream surface of the disk and are configured to impart swirl to a fluid flowing through the passages. A shroud circumferentially surrounds the disk and includes an upstream end axially separated from a downstream end, wherein the shroud is coupled to the disk.

Another embodiment is a fuel nozzle for a gas turbine that includes an annular passage configured to flow a fuel and includes a first end axially separated from a diverging second end. A disk concentric with the annular passage is disposed at the diverging second end and extends radially outward from the diverging second end. A plurality of passages extends through the disk from an upstream surface of the disk to a downstream surface of the disk. A shroud, including an upstream end axially separated from a downstream end, circumferentially surrounds and extends axially downstream from the disk and is coupled to the disk. The fuel nozzle further includes a spring at least partially surrounding the shroud.

Embodiments of the present invention may also include a combustor. The combustor generally includes an end cover. An annular passage extends from the end cover and is configured to flow a fuel. The annular passage includes a first end axially separated from a diverging second end. A disk concentric with the annular passage is disposed at the diverging second end and extends radially outward from the diverging second end. A plurality of passages extend through the disk from an upstream surface of the disk to a downstream surface of the disk. The passages are configured to impart swirl to a fluid flowing through the passages. A shroud at least partially circumferentially surrounds the disk and extends axially downstream from the disk. The combustor further includes a spring at least partially surrounding the shroud.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic view of a gas turbine engine;

FIG. 2 is an enlarged cross section view of a simplified combustor according to one embodiment of the present invention;

FIG. 3 is an enlarged perspective cut-away view of a fuel nozzle as shown in FIG. 2;

FIG. 4. is an enlarged perspective cut-away view of a cross section of the combustor as shown in FIG. 2; and

FIG. 5 is an enlarged axial cross section view of a portion of the combustor as shown in FIG. 2.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a combustor and a fuel nozzle for a gas turbine. The combustor generally includes an end cover, a casing, a fuel nozzle and a cap assembly. In particular embodiments, the fuel nozzle may include an annular passage configured to connect to the end cover and to flow a fuel and/or a diluent. The fuel nozzle may further include a disk disposed at one end of the annular passage. In particular embodiments, a plurality of passages may extend from an upstream surface of the disk through a downstream surface of the disk and may be configured to impart swirl to the fuel and/or a working fluid passing through the passages. The fuel nozzle may further include a shroud generally surrounding and extending downstream form the disk. In certain embodiments, the fuel nozzle may also include a spring and an annular plate at least partially surrounding the shroud. The cap assembly may include an annular passage and an annular impingement sleeve disposed within the annular passage and configured to receive the fuel nozzle. In this manner, the various embodiments within the scope of the present invention may increase the mechanical life of the fuel nozzle and the cap assembly without compromising cooling flow within the combustor, reduce manufacturing costs of the combustor and provide a retrofit option for existing gas turbines. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

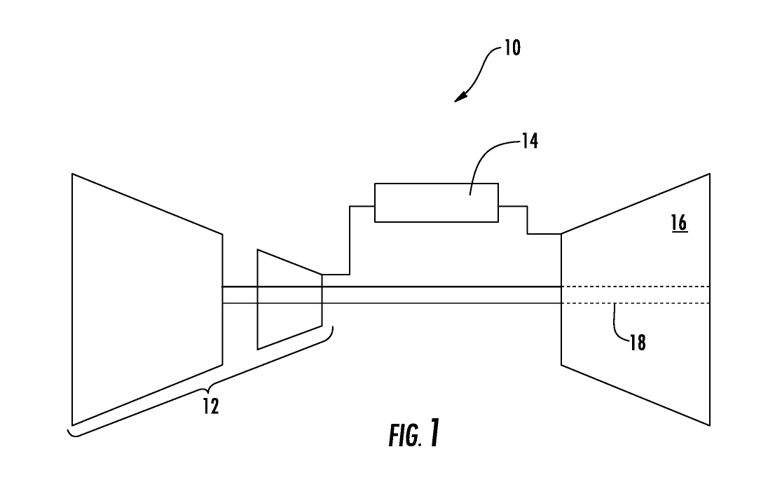

FIG. 1 provides a schematic view of a gas turbine 10. As shown, the gas turbine 10 may include a compressor 12, a combustor 14 in fluid communication with the compressor 12 and a turbine 16 downstream and in fluid communication with the combustor 14. Although a single combustor 14 is shown, the gas turbine 10 may include a plurality of combustors 14 in fluid communication with the turbine 16. In operation, a working fluid, such as air, flows through the compressor 12 to provide a compressed working fluid to the combustor 14. The compressed working fluid is mixed with a fuel and ignited within the combustor 14, thereby creating a rapidly expanding hot gas. The hot gas flows from the combustor 14 to the turbine 16. As the hot gas flows through the turbine 16, kinetic energy from the hot gas is transferred to a plurality of turbine buckets (not shown) attached to a turbine shaft 18 causing the turbine shaft 18 to rotate and produce mechanical work. The mechanical work produced may drive the compressor 12 or other external loads, such as a generator (not shown) to produce electricity.

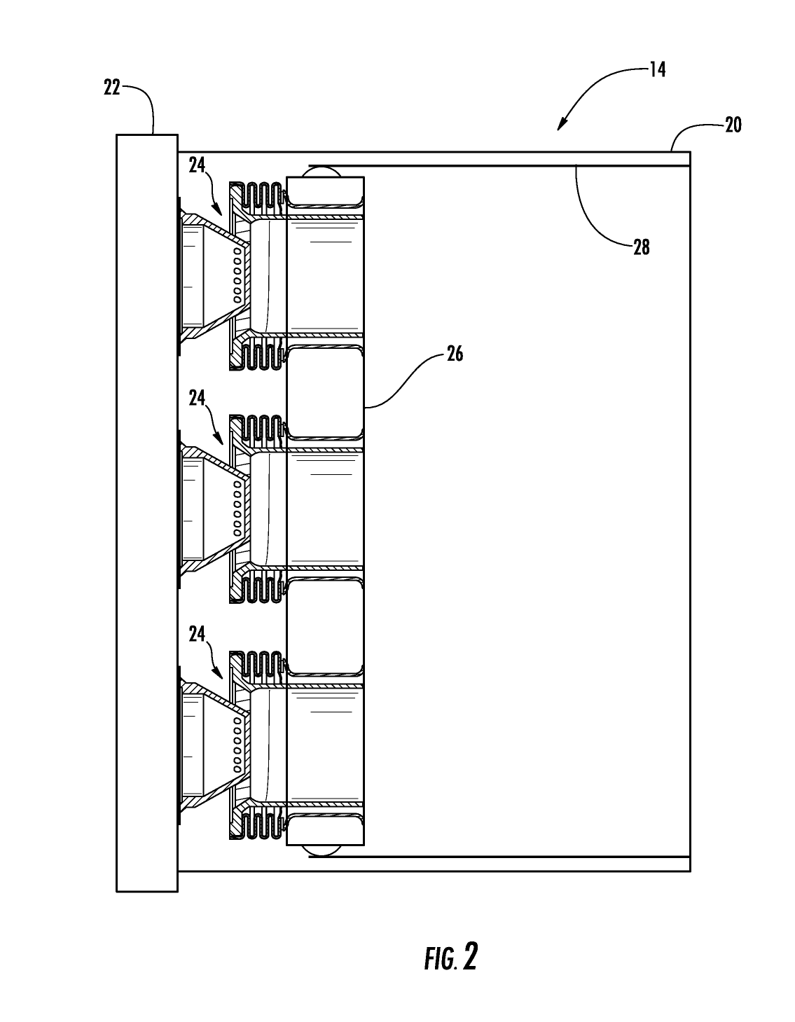

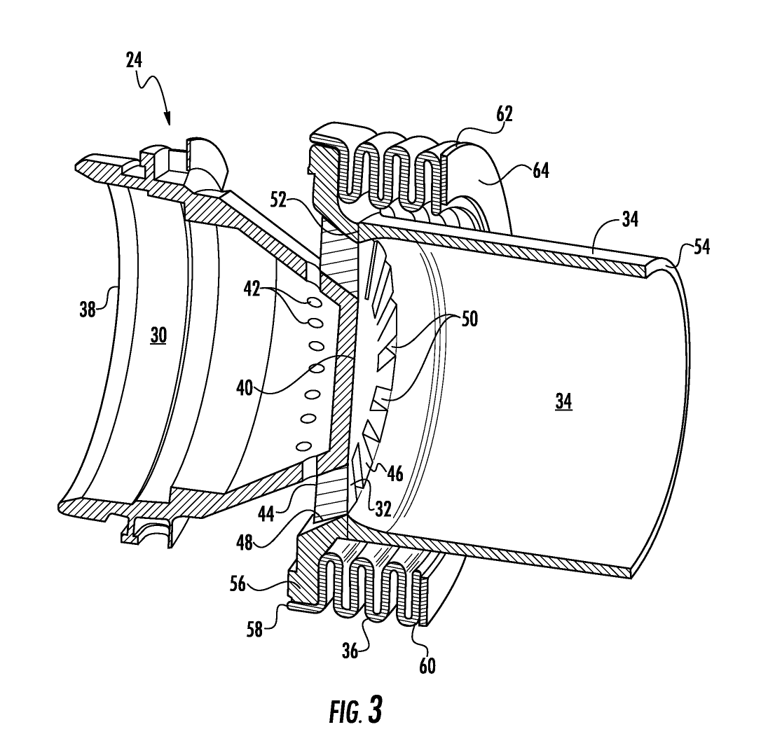

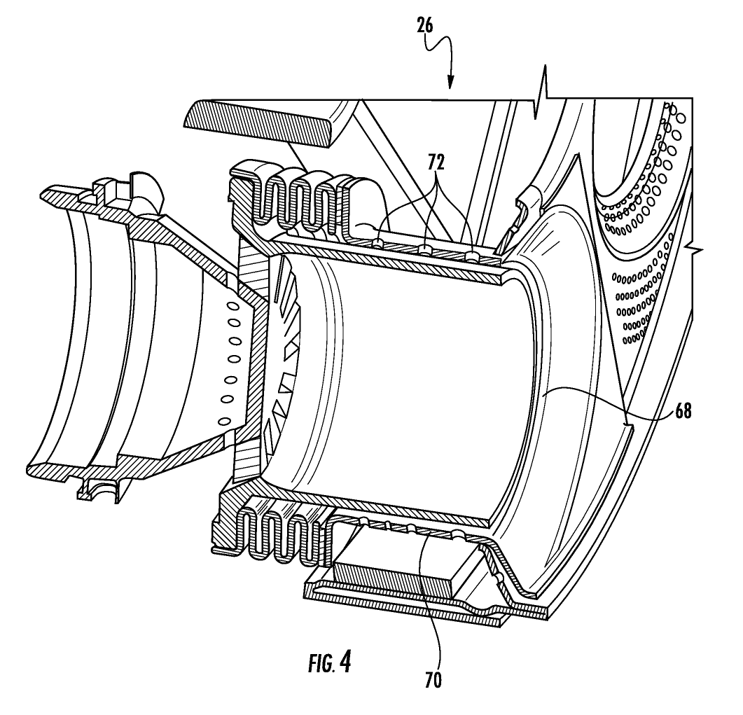

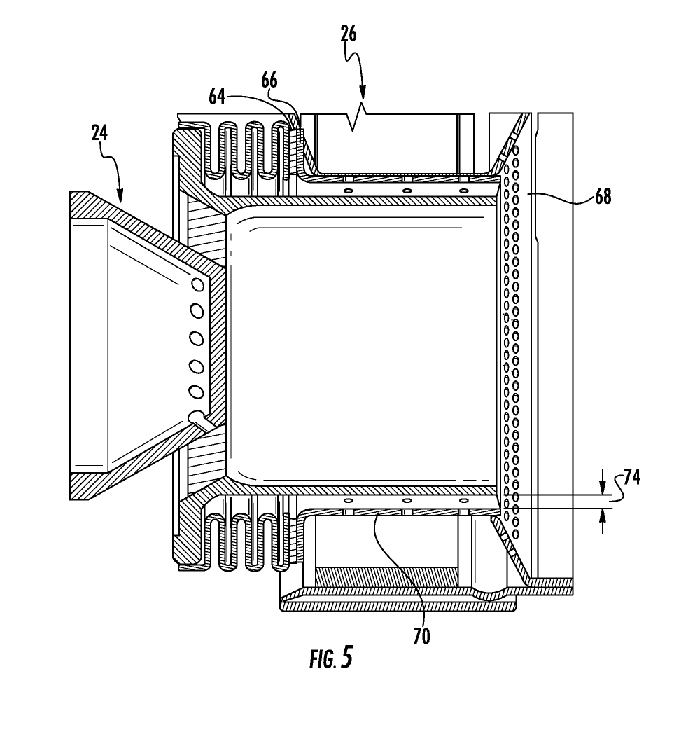

FIG. 2 provides an enlarged cross section view of a simplified combustor according to one embodiment of the present invention. FIG. 3 is an enlarged perspective cut-away view of a fuel nozzle as shown in FIG. 2, FIG. 4 is an enlarged perspective cut-away view of a cross section of the combustor as shown in FIG. 2 and FIG. 5 is an enlarged axial cross section view of a portion of the combustor as shown in FIG. 2. As shown in FIG. 2, a casing 20 generally surrounds the combustor 14 to contain a working fluid, such as compressed air, flowing to the combustor 14. The casing 20 may include an end cover 22 disposed at one end. The end cover 22 may be configured to provide a fuel and/or a working fluid to one or more fuel nozzle(s) 24 extending generally downstream from the end cover 22. The combustor 14 may further include a cap assembly 26 extending radially within the casing 20. A combustion liner 28 may at least partially surround and extend generally downstream from the cap assembly 26.

As shown in FIG. 3, the fuel nozzle(s) 24 generally include an annular passage 30, a disk 32 concentric with the annular passage 30, a shroud 34 surrounding the disk 32 and a spring 36 surrounding the shroud 34. The annular passage 30 includes a first end 38 axially separated from a second end 40. The annular passage 30 may be configured to connect to the end cover 22 and to provide fluid communication between the end cover 22 and the combustor 14. The annular passage 30 may be configured to flow at least one of a liquid fuel, a gaseous fuel and a working fluid. In particular embodiments, the annular passage 30 may diverge at the second end 40. In this manner, the fuel or working fluid flowing through the annular passage 30 may be accelerated as it flows from the first end 38 to the second end 40 of the fuel nozzle(s) 24. A plurality of ports 42 may extend radially and/or axially through the annular passage 30, thus providing a flow path for the fuel and/or working fluid to flow from the annular passage 30 and into the combustor 14. The annular passage 30 may be constructed from steel or steel alloys capable of withstanding the expected temperatures found within the combustor 14, and may be constructed of similar or dissimilar materials from that of the disk 32 and/or the shroud 34.

The disk 32 may be disposed at the second end 40 of the annular passage 30. The disk 32 may be mechanically coupled; for example, welded or brazed, or the disk may be cast and/or machined as part of the annular passage 30. The disk 32 may be constructed from steel or steel alloys capable of withstanding the expected temperatures found within the combustor 14, and may be constructed of similar or dissimilar materials from that of the annular passage 30 and/or the shroud 34. The disk 32 generally extends radially outward and axially downstream and/or upstream from the second end 40. The disk 32 also includes an upstream surface 44 axially separated from a downstream surface 46 and a circumferential outer surface 48 extending axially from the upstream surface 44 to the downstream surface 46. The disk 32 may include a plurality of passages 50 extending through the disk 32 from the upstream surface 44 to the downstream surface 46. In particular embodiments, the passages 50 may be configured to impart swirl to the fuel and/or the working fluid flowing through the passages 50. The passages 50 may be configured to impart clockwise and/or counterclockwise swirl. In this manner, the fuel and/or working fluid may premix prior to combustion, thereby resulting in a more efficient burn of the fuel and/or the working fluid and decreased NOx emissions.

The shroud 34 generally circumferentially surrounds and may be coupled to the disk 32. In alternate embodiments, the shroud 34 may be coupled to the annular passage 30. The shroud 34 may be coupled by any mechanical means, such as welding or brazing, or the shroud may be cast and/or machined as part of the annular passage 30 and/or the disk 32. The shroud 34 includes an upstream end 52 axially separated from a downstream end 54 and forms an axial flow path for the fuel and/or the working fluid. The shroud 34 may be constructed from steel or steel alloys capable of withstanding the expected temperatures found within the combustor 14, and may be constructed of similar or dissimilar materials from that of the annular passage 30 and/or the disk 32. In particular embodiments, the shroud 34 may further include a flange 56 extending radially outward from the shroud 34. The flange 56 may at least partially circumferentially surround the shroud 34 and may be disposed at any point axially along the shroud 34. In particular embodiments, the flange 56 may be coupled to the shroud 34 at or near the upstream end 52. The flange 56 may be coupled by any mechanical means, such as welding or brazing, or the flange 56 may be cast and/or machined as part of the shroud 34. The flange 56 may be constructed from steel or steel alloys capable of withstanding the expected temperatures and may be annularly or conically shaped to reduce the flow resistance as the compressed working fluid flows around the flange 56.

The spring 36 extends axially downstream from the upstream end 52 of the shroud 34 and includes a first surface 58 axially separated from a second surface 60. The first surface 58 and/or the second surface 60 may be filed or otherwise formed to provide a generally flat surface. In particular embodiments, the spring 36 may be coupled to the shroud 34. For example, the first surface 58 of the spring may be coupled to the upstream end of the shroud 34 and/or to the flange 56. The spring 36 may be coupled to the shroud 34 or to the flange 56 by any mechanical means, such as welding or brazing. In particular embodiments, as shown, the spring 36 may include a bellows spring 36. In this manner, the bellows spring 36 may provide a compressive force to seal the fuel nozzle(s) 24 with the cap assembly 26. As a result, the bellows spring 36 may form a plenum wherein the working fluid may flow to cool the fuel nozzle(s) 24. In addition, the bellows spring 36 may decrease the likelihood of misalignment in both the axial and/or radial directions between the fuel nozzle(s) 24 and the cap assembly 26 during assembly and/or operation of the combustor. In alternate embodiments, the spring 36 may include any spring 36 designed to resist compression loads. For example, the spring 36 may include a coil spring, a conical spring, a helical spring, a wave spring or a Belleville washer. The spring 36 may be constructed from steel or steel alloys or any material capable of withstanding the expected temperatures and compressive loads.

In particular embodiments, the fuel nozzle(s) 24 may include an at least partially annular plate 62 disposed on the second surface of the spring 60. As shown in FIG. 4, the plate 62 may be configured to provide a first mating surface 64 so as to form a seal between the fuel nozzle(s) 24 and the cap assembly 26. In this manner, the probability of the fuel leaking from behind the cap assembly 26 may be decreased, thereby reducing the likelihood of flashback and/or flame holding within the combustor 14. For example, as shown in FIGS. 3, and 5, the first mating surface 64 may include a flat surface and/or a grooved surface and the cap assembly 26 may include a complementary second mating surface 66. The plate 62 may be coupled to the spring 36 by any mechanical means, such as welding or brazing. The plate 62 may be constructed from steel or steel alloys or any material capable of withstanding the expected temperatures and compressive loads.

As shown in FIGS. 2, 4 and 5, the cap assembly 26 at least partially surrounds the fuel nozzle(s) 24. As shown in FIGS. 4 and 5, the cap assembly 26 generally includes one or more annular channel(s) 68 that are configured to receive the fuel nozzle(s) 24. In particular embodiments, the cap assembly 26 may include one or more annular impingement sleeve(s) 70 disposed within the annular channel(s) 68. The impingement sleeve(s) 70 may be generally larger in diameter than the shroud 34. The impingement sleeve(s) 70 may include a plurality of radially extending cooling passages 72. In this manner, the working fluid may flow through the cooling passages 72 to cool the fuel nozzle(s) 24. The impingement sleeve(s) 70 may also include the second mating surface 66 extending radially outward from and at least partially circumferentially surrounding the impingement sleeve(s) 70. The second mating surface 66 may be formed to be complementary to the first mating surface 64 of the plate 62. The impingement sleeve(s) 70 may be sized to provide a radial gap 74 between the shroud 34 and the impingement sleeve 70. In this manner, an effective cooling flow of the working fluid may be maintained to cool the fuel nozzle(s) 24 during operation of the gas turbine.

During assembly of the combustor, the fuel nozzle(s) may be inserted generally axially through the impingement sleeve. The annular plate first mating surface may seal against the impingement sleeve second mating surface due to a compressive force provided by the spring. The compressive force may also provide for proper axial and radial alignment between the fuel nozzle(s) and the cap assembly. Particularly, in the case where the cap assembly may be misaligned. During operation of the combustor, the spring may allow for thermal growth variations between the fuel nozzle(s) and the cap assembly without compromising the seal. As a result, leakage of the working fluid and/or the fuel may be significantly reduced.

The technical effect of the present matter is improved performance and/or operation of a gas turbine. In particular, by adding the shroud and and/or the spring to the fuel nozzle(s), wear between the cap assembly and the fuel nozzle(s) may be significantly reduced and the need for expensive wear coatings may be eliminated. As a result, the mechanical life of the combustor may be extended and the design simplified, thereby resulting in decreased operating costs. In addition, the design may be retrofitted to existing gas turbine combustors to increase the life of the fuel nozzle(s) and the cap assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fuel nozzle for a gas turbine comprising:
a. an annular passage configured to flow a fuel including a first end axially separated from a second end;
b. a disk concentric with the annular passage and disposed at the second end, the disk extending radially outward from the second end;
c. a plurality of passages extending through the disk and configured to impart swirl to a fluid flowing through the passages; and
d. a shroud circumferentially surrounding the disk and including an upstream end axially separated from a downstream end, wherein the shroud is coupled to the disk.

2. The fuel nozzle of claim 1, further comprising a flange coupled to the upstream end of the shroud, the flange extending radially outward from and circumferentially surrounding at least a portion of the upstream end of the shroud.

3. The fuel nozzle of claim 1, wherein the fuel nozzle further comprises a spring at least partially surrounding the shroud, the spring extending axially downstream from the upstream end of the shroud.

4. The fuel nozzle of claim 3, wherein the spring is coupled to the upstream end of the shroud.

5. The fuel nozzle of claim 3, wherein the spring includes a bellows spring.

6. The fuel nozzle of claim 3, wherein an annular plate at least partially circumferentially surrounds the shroud and is coupled to a downstream end of the spring.

7. The fuel nozzle of claim 3, further comprising a flange coupled to the upstream end of the shroud, the flange extending radially outward from and circumferentially surrounding at least a portion of the upstream end of the shroud, wherein the spring is coupled to the flange.

8. A fuel nozzle for a gas turbine comprising:
a. an annular passage configured to flow a fuel including a first end axially separated from a diverging second end;
b. a disk concentric with the annular passage and disposed at the diverging second end, the disk extending radially outward from the diverging second end;
c. a plurality of passages extending through the disk from an upstream surface of the disk to a downstream surface of the disk;
d. a shroud including an upstream end axially separated from a downstream end, the shroud circumferentially surrounding and extending axially downstream from the disk, wherein the shroud is coupled to the disk; and
e. a spring at least partially surrounding the shroud.

9. The fuel nozzle of claim 8, wherein the spring includes a bellows spring.

10. The fuel nozzle of claim 8, wherein the spring is coupled to the upstream end.

11. The fuel nozzle of claim 8, wherein an annular plate at least partially circumferentially surrounds the shroud and is coupled to a downstream end of the spring.

12. The fuel nozzle of claim 8, wherein the passages are configured to impart swirl to a fluid flowing through the passages.

13. The fuel nozzle of claim 8, wherein the shroud further comprises a flange extending radially outward from and circumferentially surrounding at least a portion of the upstream end.

14. The fuel nozzle of claim 13, wherein the spring is coupled to the flange.

15. A combustor comprising:
a. an end cover;
b. an annular passage extending from the end cover and configured to flow a fuel including a first end axially separated from a diverging second end;
c. a disk concentric with the annular passage and disposed at the diverging second end, the disk extending radially outward from the diverging second end;
d. a plurality of passages extending through the disk from an upstream surface of the disk to a downstream surface of the disk, the passages configured to impart swirl to a fluid flowing through the passages;
e. a shroud coupled to the disk, the shroud at least partially circumferentially surrounding the disk and extending axially downstream from the disk; and
f. a spring at least partially surrounding the shroud.

16. The combustor of claim 15, wherein the spring includes a bellows spring.

17. The combustor of claim 15, wherein an annular plate at least partially circumferentially surrounds the shroud and is coupled to a downstream end of the spring.

18. The combustor of claim 15, further comprising a cap assembly extending generally radially within the combustor and including an upstream surface axially separated from a downstream surface, wherein the cap assembly is configured to at least partially surround the shroud.

19. The combustor of claim 18, wherein the cap assembly includes an annular impingement sleeve configured to at least partially surround the shroud.

20. The combustor of claim 19, wherein a radial gap is provided between the shroud and the impingement sleeve.
